(19) United States
(12) Patent Application Publication
(10) Pub. No.: US 2021/0316500 A1
(43) Pub. Date: Oct. 14, 2021

(54) SYSTEM AND APPARATUS FOR RANDOMIZING FIBER ADDITIVES IN ADDITIVE MANUFACTURING

(71) Applicant: Airtech International, Inc., Huntington Beach, CA (US)

(72) Inventors: Zachary Skelton, Laguna Hills, CA (US); Aubrey Jackson, Costa Mesa, CA (US); Robert Bedsole, Nashville, TN (US)

(21) Appl. No.: 17/225,631

(22) Filed: Apr. 8, 2021

Related U.S. Application Data
(60) Provisional application No. 63/007,211, filed on Apr. 8, 2020.

(51) Int. Cl. B29C 64/118; B29C 64/209; B29C 64/314; B29C 64/295; B29C 64/343; B33Y 10/00; B33Y 30/00; B33Y 40/00

(52) U.S. Cl. CPC B29C 64/118; B29C 64/209; B29C 64/314; B33Y 40/00; B29C 64/343; B33Y 10/00; B33Y 30/00; B29C 64/295

(57) ABSTRACT

An extrusion system including an extruder screw housed in a barrel, a nozzle heater coupled to the barrel, a printing nozzle coupled to the nozzle heater, and a randomizing element at least partially in the printing nozzle. The randomizing element is configured to randomize the orientation of fiber elements and/or fillers in an extrusion melt traveling through the extrusion system. Increasing the randomization of the fiber orientations in the melt composition improves the physical and thermal properties of a printed bead printed by the extrusion system.

### CROSS-REFERENCE TO RELATED APPLICATION(S)

This application claims priority to and the benefit of U.S. Provisional Application No. 63/007,211, filed Apr. 8, 2020, the entire content of which is incorporated herein by reference.

### BACKGROUND

### 1. Field

The present application relates to a system, an apparatus, and a method for randomizing fiber elements or fillers in an additive manufacturing process.

### 2. Description of the Related Art

Additive manufacturing processes are utilized to manufacture a wide variety of different components and the components may be additively manufactured with a variety of different materials, such as polymers, metals, and alloys. When used in additive manufacturing processes, the polymers being printed typically exhibit highly anisotropic behavior. This highly anisotropic behavior of the polymers is primarily due to attempts to control the thermal expansion, strength, and warpage of the printed (i.e., additively manufactured) material (or structure). The polymer materials used in these manufacturing techniques can be modified by the addition of certain fibers to, for example, modify the coefficient of thermal expansion (CTE), increase strength, and/or reduce warpage in the extruded or printed polymer. However, in conventional additive manufacturing processes, the added fibers within the polymer matrix tend to align along the axial direction of the extrusion, which results in a printed bead that has different physical and thermal expansion properties in the print direction, across the bead width, and through the bead thickness. In fact, the axial alignment of the fibers within the polymer matrix leads to significant dissimilarities in a wide variety of mechanical and thermal properties.

### SUMMARY

The present application relates to various embodiments of an extrusion system. In one embodiment, the extrusion system includes an extruder screw housed in a barrel, a nozzle heater coupled to the barrel, a printing nozzle coupled to the nozzle heater, and a randomizing element at least partially in the printing nozzle. The randomizing element is configured to randomize an orientation of fiber elements and/or fillers in an extrusion melt traveling through the extrusion system.

The present disclosure also relates to various embodiments of a method of randomizing fiber elements and/or fillers in a melted polymer composition to be printed by an extrusion system. In one embodiment, the method includes supplying a feedstock including the fiber elements and/or the fillers to an extruder screw of the extrusion system, melting the feedstock as the feedstock moves along the extruder screw to form a melted composition including the fiber elements and/or the fillers, and randomizing the orientation of the fiber elements and/or the fillers in a printing nozzle of the extrusion system.

The present disclosure also relates to various embodiments of a method of printing a part by additive manufacturing. In one embodiment, the method includes supplying a feedstock (including fiber elements and/or fillers) to an extruder screw housed in a barrel of an extrusion system, heating the barrel of the extrusion system to melt the feedstock while it travels along the extruder screw to form a melted composition including the fiber elements and/or the fillers, randomizing the orientation of the fiber elements and/or the fillers in the melted composition by passing the melted composition through a randomizing element at least partially in a printing nozzle of the extrusion system, and printing, with the printing nozzle, the melted composition into a bead to form at least a portion of the part, wherein the fiber elements and/or the fillers remain randomized after printing.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

Features and advantages of embodiments of the present disclosure will be better understood by reference to the following detailed description when considered in conjunction with the drawings, in which:

FIG. 1A is a schematic depicting a system (or apparatus) for extrusion according to embodiments of the present disclosure including a barrel, an extrusion screw, a melt pump, a nozzle heater, a nozzle, and a randomizing element;

FIGS. 1B and 1C are schematics depicting the system depicted in FIG. 1A in a horizontal layer printing (HLP) configuration and a vertical layer printing (VLP) configuration, respectively;

FIGS. 2A through 2G are cut-away schematic views of the print end of the system depicted in FIG. 1A, showing different configurations of the randomizing element, printing nozzle and nozzle heater according to embodiments of the present disclosure; and

FIG. 3A is a schematic depicting random fiber orientation of the melt stream when using an extrusion system according to embodiments of the present disclosure;

FIG. 3B is a schematic depicting alignment of fibers in the melt stream when using an extrusion system according to the prior art;

FIGS. 4A through 4C are a perspective view, and a side view, and an end view, respectively, of a randomizing element according to one embodiment of the present disclosure; and

FIG. 5 is a flowchart depicting tasks of a method of randomizing fiber additives in an extrusion melt, or a method of printing (or extruding, or additively manufacturing) an extrusion melt having fiber additives, according to one embodiment of the present disclosure.

### DETAILED DESCRIPTION

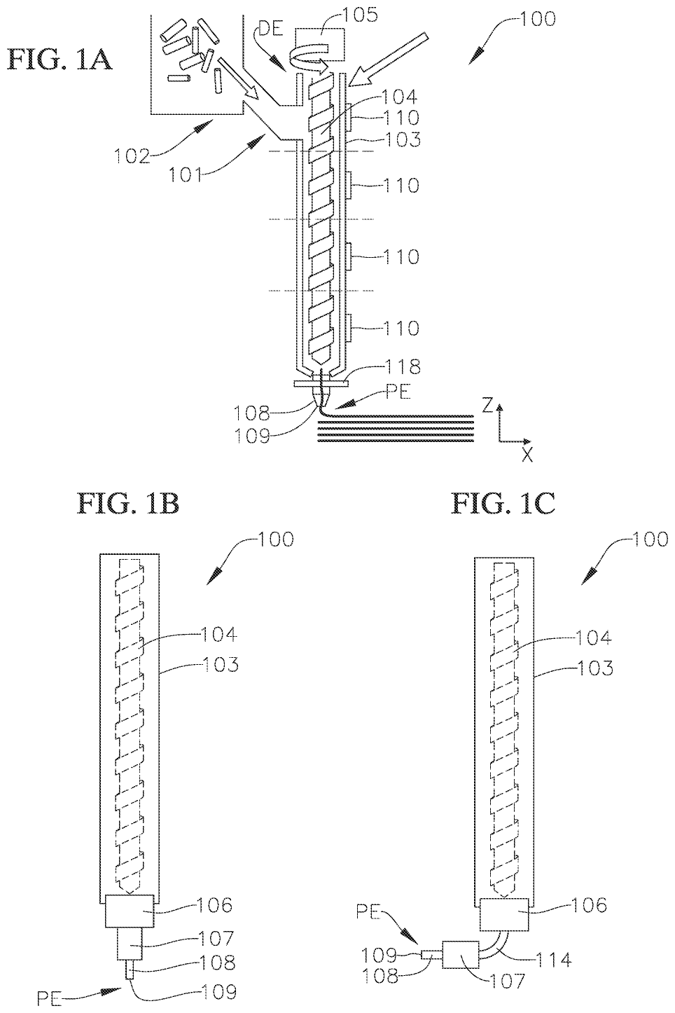

According to embodiments of the present disclosure, a system and apparatus for additive manufacture includes a randomizing element adjacent (e.g., directly adjacent) the printing nozzle. The randomizing element extends into the printing nozzle to minimize (or eliminate) the distance traveled by the extrusion melt after exiting the randomizing element and being printed out of the printing nozzle. This construction ensures that the extrusion melt exiting the printing nozzle and being deposited has a generally or substantially uniform composition. When the melt composition includes fiber additives and/or fillers, this construction enables improved randomization of the fiber and/or filler orientations in the melt composition, which, in turn, enables improved physical and thermal properties of the printed composition (e.g., consistent properties in the x, y and z dimensions (length, width, and height) of the printed bead or composition, as shown in FIG. 1A.

In some embodiments, for example, a system and apparatus for extrusion (or additive manufacturing, or printing) includes a randomizing element for randomizing fiber additives and/or fillers (e.g., fillers having an aspect ratio such that the fillers would otherwise tend to align with the melt flow direction) in the extrusion melt. According to embodiments, the randomizing element has a first end located in the component (e.g., the nozzle heater) adjacent (or immediately adjacent) to the printing nozzle, and a second end extending into the printing nozzle to minimize (or eliminate) the distance between the second end of the randomizing element and the printing nozzle exit port. While the systems and apparatus depicted and described herein reference extrusion apparatus and systems, it is understood that the concepts can be integrated in any manufacturing machinery or system which would benefit from randomized orientation of fiber additives and/or fillers (or improved homogenization or uniformity) in a melt prior to printing (or otherwise depositing) the melt. Also, while the systems and apparatus are described as useful in extruding, printing or depositing certain melt compositions, it is understood that any suitable melt composition may be used with the described systems and apparatus. Indeed, although the systems and apparatus are described as useful in randomizing the orientation of fiber additives in the melt just prior to printing the extrusion bead, it is understood that the described systems and apparatus are also useful in improving the homogeneity of the melt prior to printing regardless of the melt composition or the additives in the melt. Accordingly, the systems and apparatus described herein may be used to homogenize or more uniformly mix and reorient any melt composition containing any type of additive, regardless of the geometry of the additive.

In some embodiments, as depicted generally in FIGS. 1-1B, a system 100 for extrusion includes a driving end DE and a printing end PE. At the driving end DE, the system 100 includes a hopper 102, a barrel 103 housing an extruder screw 104, and a screw motor 105 for driving the extruder screw 104. The hopper 102 houses an extrusion feedstock (e.g., raw resin or polymer, or a resin or polymer mix including an additive or other components), and is in communication with the barrel 103 via a feed throat 101 to feed the feedstock into the barrel 103. The extrusion feedstock (e.g., pellets) are vacuum fed periodically from a dryer system to the hopper 102 to maintain the hopper 102 filled to a preset level utilizing a sensor. The screw motor 105 powers and drives the extruder screw 104, which rotates and pushes the feedstock longitudinally along the length of the barrel 103 toward the printing end PE of the system 100. The hopper 102 may be any size suitable for the intended application of the system 100, such as a volume in a range from approximately ½ gallon to approximately 5 gallons.

At the printing end PE, the system 100 includes a melt pump 106 in communication with the barrel 103, a nozzle heater 107 in communication with the melt pump 106, and a printing (or extrusion) nozzle 108 in communication with the melt pump 106. In one or more embodiments, the system 100 may not include the melt pump 106. As the feedstock exits the barrel 103 at the printing end PE, the feedstock enters the melt pump 106, which pumps the feedstock to the nozzle heater 107. Upon entering the nozzle heater 107, the feedstock (or melt) is heated to ensure appropriate viscosity and flow, and then passes to the printing nozzle 108 where it exits through a printing exit port 109 in the nozzle 108 and is deposited (or printed) as a bead onto the desired substrate (or onto a previously printed layer). In one or more embodiments, the system 100 may include a roller configured to compress the printed or deposited bead. In one or more embodiments, the system 100 may include any other suitable mechanism for compressing the printed or deposited bead, such as a tamper 118 (e.g., a plate configured to vibrate up and down at high frequency during printing, as depicted in FIG. 1A). In one or more embodiments, the system 100 may include a roller, a tamper, and/or any other suitable mechanism to break the printed or deposited bead (e.g., the extrudate from the nozzle 108) at the end of a toolpath during a printing operation so that the printed or deposited bead does not lift off the part as the printhead (e.g., the nozzle 108) moves to a new location on the part. The system 100 may be configured for either horizontal layer printing (HLP), as shown in FIG. 1B, or vertical layer printing (VLP), as shown in FIG. 1C. In an embodiment in which the system 100 is configured for VLP, the system 100 also includes an angled conduit 114 (e.g., an elbow) between the nozzle heater 107 and the melt pump 106 which orients the nozzle 108 and the nozzle heater 107 at an angle (e.g., a 90° angle) with respect to the melt pump 106 and the barrel 103. In one or more embodiments, with the exception of the addition of a randomizing element in the nozzle 108, described in detail below, the system 100 may be the same as, or similar to, the Cincinnati Big Area Additive Manufacturing (BAAM), Oak Ridge National Laboratory, available at https://info.ornl.gov/sites/publications/files/Pub54708.pdf, the entire content of which is incorporated herein by reference. In one or more embodiments, with the exception of the addition of a randomizing element in the nozzle 108, described in detail below, the system 100 may be the same as, or similar to, the Large Scale Additive Manufacturing (LSAM) available at http://thermwood.com/lsam/brochures/lsam2019_imper_metricsm.pdf, the entire content of which is incorporated herein by reference.

The function and components of an extrusion line, system or apparatus (including the structure and interaction of the hopper 102, barrel 103, extruder screw 104, screw motor 105, melt pump 106, and printing (or extrusion) nozzle 108) are well known in the relevant field, and therefore are not described in detail in this disclosure. However, it is understood that each of these components may have any suitable structure and configuration that is known in the art. For example, while embodiments of the extruder screw are described as including a single extruder screw, it is understood that a twin extruder screw can also be used. Additionally, it is understood that the components of the extrusion (or printing) system and apparatus may interact with each other in any suitable way known in the art or known to those of ordinary skill in the art.

The barrel 103 (and optionally the extruder screw 104) may be heated in order to melt and mix the feedstock. Heating the barrel 103 may be accomplished in any suitable manner and with any suitable equipment, as would be understood by those of ordinary skill in the art. For example, the entire barrel 103 may be heated at a single temperature, or the barrel 103 may be divided into two or more different heat zones. In some embodiments, for example, the barrel 103 may be divided into 3 or more heat zones, or 4 heat zones.

Whether the barrel 103 is heated at a single temperature, or divided into two or more heat zones, heating the barrel 103 (or the heat zones) may be accomplished in any suitable manner. For example, in some embodiments, the barrel 103 may increase in temperature simply due to the operation of the extrusion system or apparatus. Specifically, as the feedstock enters the barrel 103, and the extruder screw 104 forces the feedstock forward along the length of the barrel 103, the friction between the molecules of the feedstock, between the feedstock and the barrel, and between the feedstock and the extruder screw will create heat within the barrel that aids in the melting of the feedstock. However, in some embodiments, to speed or otherwise aid the melting of the feedstock, external heating elements 110 may be provided on the exterior of the barrel 103. While a single heating element 110 may be used to heat the barrel 103 in this manner, in some embodiments, multiple such heating elements 110 may be used.

When multiple heating elements 110 are used, they may be arranged (or located) on the barrel in any suitable configuration and/or on other components of the system 100. For example, in some embodiments, each heat zone on the barrel carries its own heating element 110. However, in some embodiments, the multiple heating zones may be established by use of fewer heating elements 110 than heat zones. Indeed, as the friction within the barrel 103 during operation of the extrusion system and apparatus also creates heat within the barrel 103, it is understood that one or more of the heat zones in the multiple heat zone embodiments may include the barrel 103 only without any heating element 110. Accordingly, in some embodiments in which one or more of the heat zones on the barrel are established by such friction, these friction heat zones do not carry heating elements. As such, in some embodiments, the barrel may have multiple heat zones, at least one of which does not carry a heating element 110.

The temperature at (or to) which the barrel or any of the heat zones of the barrel are heated is not particularly limited, and may vary depending on the composition of the feedstock. Additionally, in embodiments in which the barrel 103 is divided into two or more heat zones, the individual heat zones may be heated at (or to) different temperatures, or the same temperature. For example, the barrel 103 may be divided into two or more heat zones in order to accommodate the number of external heating elements 110 necessary to heat the entire length of the barrel. In such a configuration, the external heating elements 110 may be set to the same temperature to maintain a consistent temperature of the barrel, or the heating elements 110 may be set to different temperatures to create a temperature gradient along the barrel 103. In one embodiment, the system 100 may include three heaters (e.g., three heater zones) in the barrel 103, one heater in a transition between the barrel 103 and the melt pump 106, one heater in the melt pump 106, and one heater in the nozzle 108.

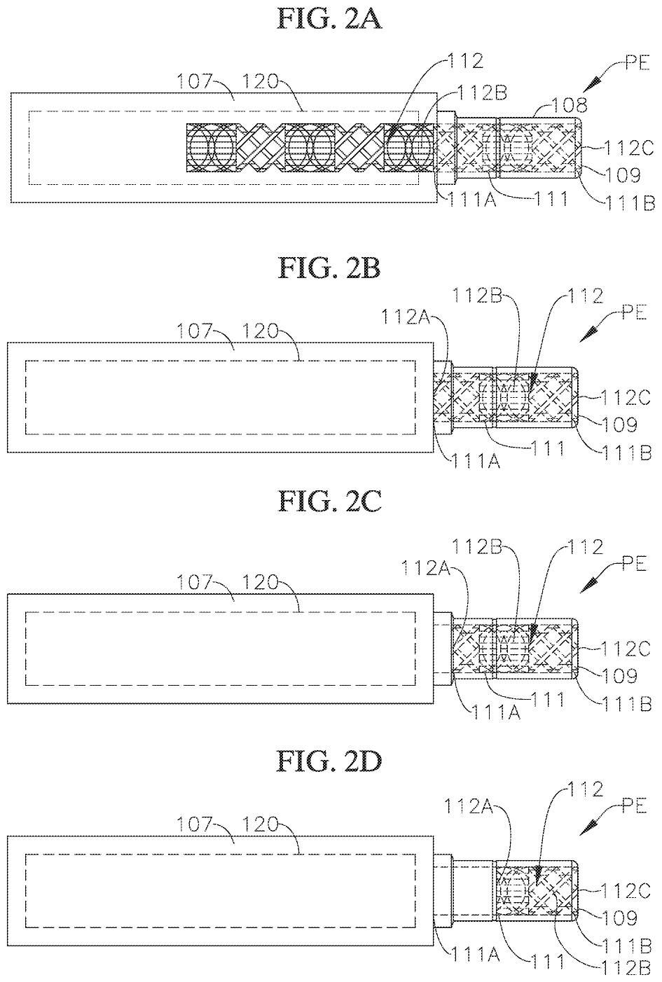

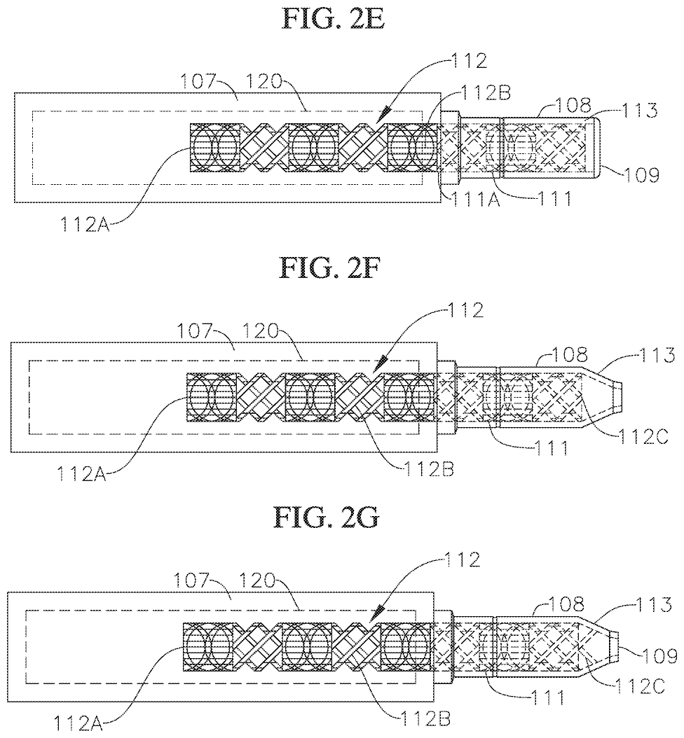

As discussed above, and as best shown in FIG. 1A, the printing end PE of the extrusion system and apparatus includes the melt pump 106, nozzle heater 107 and printing nozzle 108. According to embodiments of the present disclosure, as shown for example in FIGS. 2A-2G, the printing end PE of the system also includes a randomizing element 112 at least a portion of which is housed in the printing nozzle 108. In some embodiments, at least a portion of the randomizing element 112 may be housed in the nozzle heater 107. For example, in some embodiments, as shown generally in FIG. 2A, the randomizing element 112 may have a first end 112a located (or terminating) in the nozzle heater 107, and a second end 112c located (or terminating) in the printing nozzle 108. In such embodiments, the randomizing element 112 may have a mid-section 112b that spans between the printing nozzle 108 and the nozzle heater 107. The location (or termination) of the first end 112a of the randomizing element 112 is not limited to this configuration, and in fact, the first end 112a may be located (or terminated) anywhere downstream of the melt pump 106. For example, while FIG. 2A shows the first end 112a terminating near a mid-section of the nozzle heater 107, the first end 112a may alternatively terminate at the end of the nozzle heater 107 (i.e., at the junction between the nozzle heater 107 and the printing nozzle 108), as shown in FIG. 2B. Additionally, in other embodiments, the first end 112a of the randomizing element may not be located in the nozzle heater 107 at all, and may instead terminate either just before the junction between the nozzle heater 107 and the printing nozzle 108 (as shown in FIG. 2C) or anywhere along the length of the printing nozzle 108, such as, for example, near a mid-section of the printing nozzle 108 (as shown in FIG. 2D).

The diameter of the randomizing element 112 is not particularly limited, but should be selected to minimize space between an outer surface of the randomizing element 112 and the inner wall of the printing nozzle 108 (e.g., the randomizing element 112 may be received in the printing nozzle 108 with a form fit or a friction fit). In one or more embodiments, the randomizing element 112 may be integrally formed with the printing nozzle 108. In one or more embodiments, the randomizing element 112 may have any suitable diameter so long as flow through the nozzle 108 can be maintained and pressure does not exceed the limitations of the system 100. The diameter of the randomizing element 112 may be in a range from approximately 0.1 mm to approximately 50 mm. The printing nozzle 108 includes a sleeve 111 that is open at a first end 111a and has the printing exit port 109 at a second end 111b. In some embodiments, as can be seen in FIGS. 2A-2G, because the sleeve 111 of the printing nozzle 108 has a smaller diameter than the diameter of the nozzle heater 107, the randomizing element 112 may have a smaller diameter than the diameter of the nozzle heater 107. In such embodiments, the portion of the randomizing element 112 that extends into the nozzle heater 107 may extend through an inner tubing or channel 120 (e.g., a bushing) in the nozzle heater 107. The inner tubing or channel 120 serves to direct the melt from the melt pump through the randomizing element 112 and into the printing nozzle 108.

In some embodiments, as shown generally in FIGS. 2A-2D, the second end 112c of the randomizing element 112 is generally flush with the exit port 109 of the printing nozzle 108. While this configuration is suitable and produces satisfactory printed products, in some embodiments, the sleeve 111 of the printing nozzle 108 may include a short neck 113 extending past the second end 112c of the randomizing element 112. This short neck 113 may simply extend past the end 112c of the randomizing element 112 with the same diameter, as shown in FIG. 2E. Alternatively, the short neck may taper from the second end 112c of the randomizing element 112 to the exit port 109 of the printing nozzle 108, as shown in FIG. 2F. The short neck 113 serves to reorient the flow of melt exiting the randomizing element 112. Specifically, when the end of the randomizing element 112a is flush (or generally flush) with the exit port 109 of the printing nozzle 108, the melt may exit the printing nozzle 108 in a flow having multiple different directions (depending on the geometry of the randomizing element 112). In embodiments including the short neck 113, however, the melt exits the randomizing element 112 and passes through the short neck 113 before exiting the printing nozzle 108. With such a construction, even if the melt exits the randomizing element 112 in a flow with multiple different directions, the short neck 113 gathers the melt from all different directions and focuses the flow into a single stream, creating a consistent exit direction of the print bead at the exit port 109 of the printing nozzle (i.e., along the axial direction of the printing nozzle 108). That is, in one or more embodiments, the randomizing element 112 may introduce large scale porosity (e.g., voids) in the melt, and the short neck 113 is configured to reduce the large-scale porosity.

The length and diameter of the short neck 113 are not particularly limited so long as the short neck 113 is capable of focusing the melt exiting the randomizing element 112 and reducing the large-scale porosity (e.g., the voids) in the melt introduced by the randomizing element 112. However, to ensure that any fibers in the melt do not align with the inner wall of the short neck 113 while exiting the printing nozzle 108, the short neck 113 should have a length that is as short as possible, i.e., short enough to prevent alignment of the fibers and/or fillers along the inner wall (e.g., along the sleeve 111), but long enough to focus the flow of the melt exiting the randomizing element 112 and reduce the presence of large voids in the melt. Indeed, this short length of the short neck 113 ensures that any fiber additives and/or fillers in the extrusion melt do not reorient to an axial alignment (e.g., along the inner walls of the printing nozzle 108) in any significant degree, thus maintaining a random alignment (as defined below) of the fibers within the melt. This results in a printed bead (or material) having generally or substantially uniform properties in the x, y and z directions (length, height, and width). In one or more embodiments, the length of the short neck 113 may be in a range from approximately 0 mm to approximately 200 mm. In one or more embodiments, the length of the short neck 113 may be in a range from approximately 0 mm to approximately 100 mm. In another embodiment, the length of the short neck 113 may be in a range from approximately 0 mm to approximately 50 mm. In one or more embodiments, the length of the short neck 113 may be selected based on the material of the melt (e.g., a relatively shorter short neck 113 for melt material having a lower viscosity, and a relatively longer short neck 113 for a melt material having a higher viscosity).

Additionally, in some embodiments, the printing nozzle 108 may itself have a tapered construction, such as that shown, for example, in FIGS. 2F-2G. In such embodiments, the randomizing element 112 may also have a tapered configuration or a stepped configuration such that its diameter (or cross-section) changes along the length of the randomizing element 112. For example, to fit the randomizing element 112 in such a tapered printing nozzle 108, in some embodiments, the second end 112c of the randomizing element 112 has a smaller diameter than the mid-section 112b and the first end 112a. The smaller diameter of the second end 112c of the randomizing element 112 enables the second end to fit within the printing nozzle 108. As the second end 112c of the randomizing element 112 fits in the tapered printing nozzle 108, the extrusion melt exiting the randomizing element needs to travel only a very short distance after exiting the randomizing element 112 before being printed out of the exit port 109 of the printing nozzle 108. As noted above, this short distance ensures that any fiber additives and/or fillers in the extrusion melt do not reorient to an axial alignment (e.g., along the inner wall(s) of the printing nozzle 108) in any significant degree, thus maintaining a random alignment of the fibers and/or fillers within the melt. This results in a printed bead (or material) having generally or substantially uniform properties in the x, y and z directions.

In embodiments in which the printing nozzle 108 is tapered or otherwise has a non-uniform diameter or cross-section, the diameter of the randomizing element 112 may change along the length of the element, as discussed generally above. In these embodiments, the diameters of the first end 112a, mid-section 112b and second end 112c of the randomizing element 112 are not particularly limited so long as the second end 112c can fit inside the printing nozzle 108, and the mid-section 112b and first end 112a can fit inside their respective housings (e.g., the nozzle heater 107 or the inner tubing or channel 120 in the nozzle heater 107). The mid-section 112b of the randomizing element 112 may have the same diameter as the first end 112a, but in some embodiments, the mid-section 112b may have a diameter that is slightly different (i.e., either slightly smaller or slightly larger) than the diameter of the first end 112a. For example, in embodiments in which the first end 112a of the randomizing element 112 terminates in the melt pump 106 and the mid-section 112b extends into (or through) the nozzle heater 107, if the nozzle heater 107 has an inner diameter slightly smaller or larger than the melt pump 106, the mid-section 112b may have a diameter sized according to the inner diameter of the nozzle heater 107. It is also understood that the printing nozzle 108 is not limited to a straight or tapered configuration, and may instead have any suitable configuration or geometry. For example, instead of a continuous and smooth taper, the printing nozzle 108 may have a more stepped (or otherwise discontinuous) configuration in which the diameter of the printing nozzle 108 decreases in a step-wise fashion from one end to the other.

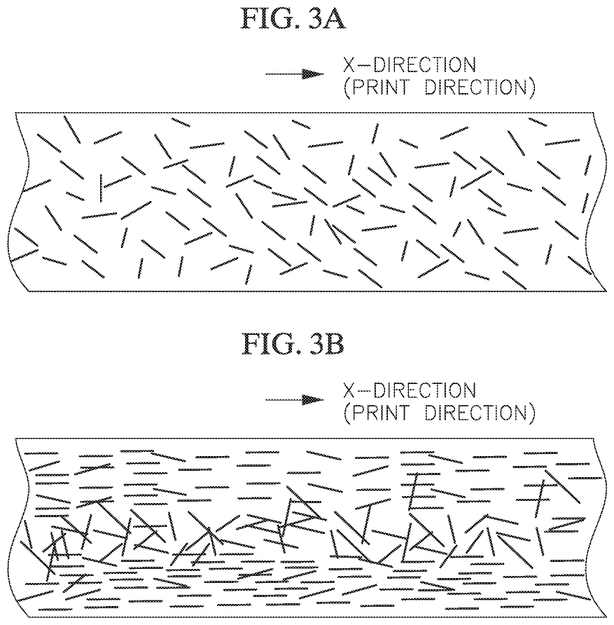

The geometry of the randomizing element 112 is also not particularly limited so long as the randomizing element 112 is capable of maintaining the general homogeneity of the melted feedstock exiting the melt pump 106, and maintaining any fiber materials in the feedstock in a generally or substantially random orientation (i.e., by preventing axial alignment, or substantial axial alignment, of the fibers along the inner wall of the nozzle heater 107 or printing nozzle 108). As used herein, the term “random orientation” refers to the orientation of the fibers relative to each other and relative to the axial direction or orientation of the extrusion apparatus. More specifically, by “random orientation” is meant that large numbers of the fibers generally do not align in any one common direction (including the axial direction) such that no pattern of the fibers in any given section or cross-section of the melted feedstock could be observed or discerned, as shown generally in FIG. 3A. In contrast, in conventional extrusion systems that do not include a randomizing element in the printing nozzle, fiber additives may remain “random” near the middle of the melt stream, but as the melted feedstock moves further downstream the fibers begin to align themselves in the axial direction in the areas of the stream in contact with the inner walls of the components of the extrusion system, as shown generally in FIG. 3B. In one or more embodiments, the randomizing element 112 of the system 100 is configured to reduce the axial alignment of the fibers in the melted feedstock after exiting the printing nozzle 108 compared to an otherwise equivalent system without the randomizing element 112 in the printing nozzle. For instance, in a conventional system without the randomizing element in the nozzle, approximately 70% of the fibers in a central portion of the bead, and approximately 90% of the fibers in an outer portion of the bead, align in the axial direction of the melted feedstock, whereas in the system of the present disclosure with the randomizing element 112 in the printing nozzle 108, less than 70% of the fibers the central portion of the bead (such as less than 60%, less than 50%, or less than 40%), and less than 90% of the fibers in the outer portion of the bead (such as less than 80%, less than 70%, or less than 60%), align along the axial direction of the melted feedstock after exiting the printing nozzle 108. Additionally, the term “random orientation” does not preclude the fibers in the feedstock being oriented in a predictable, repeatable, or reproducible manner. For instance, the random orientation of the fibers in the feedstock (e.g., the relatively heterogeneous orientation of the fibers in the feedstock) may be known a priori for a given configuration of the randomizing element 112 so long as the randomizing element 112 reduces the axial alignment of the fibers in the feedstock compared to an otherwise identical system without the randomizing element 112.

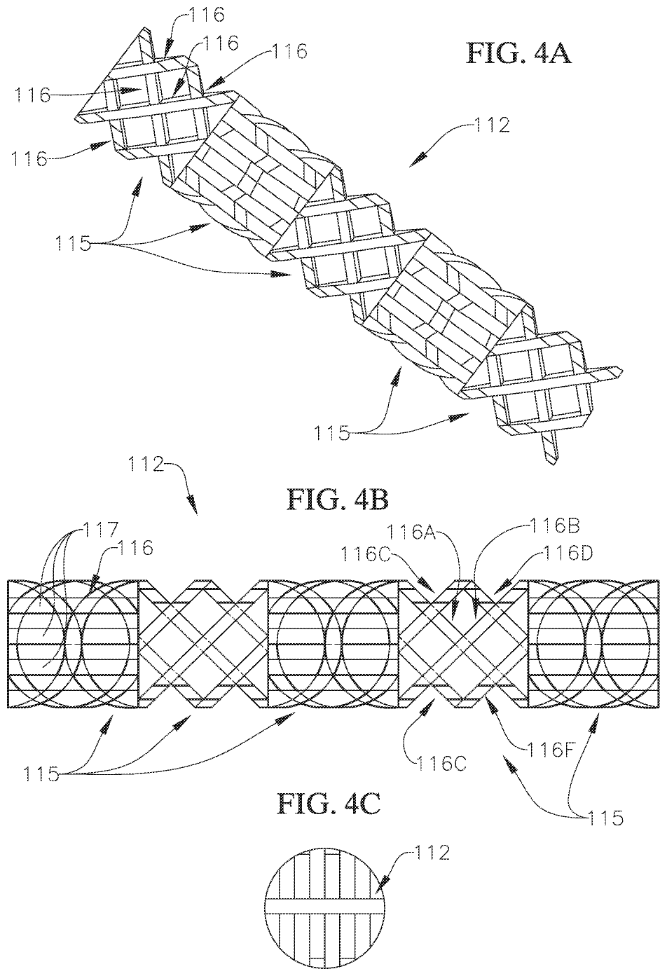

As noted generally above, this randomizing orientation of the fibers in the melt can be achieved with any suitable randomizing element geometry and configuration. However, the randomizing element 112 must also allow the melt to proceed through the randomizing element 112 and printing nozzle 108 at a sufficient flow rate to enable continuous and uninterrupted flow to the printing exit port of the printing nozzle 108. According to some embodiments, the randomizing element 112 can accomplish these dual goals by employing multiple modules having either the same or different geometries, and connecting these modules together. For example, as shown generally in FIG. 4, each module 115 of the randomizing element may include a three dimensional grid element. As can be seen in FIG. 4, the three dimensional grid element may include a plurality of generally circular or ovular grates 116 that are interwoven or meshed to form the three dimensional grid pattern. Each of the grates 116 includes a plurality of struts 117 extending a common direction. To form the three-dimensional grid pattern, the grates 116 are arranged such that the struts 117a of a first grate 116a are nestled in the spaces between the struts 117b of a second grate 116b (e.g., the struts 117a of the first grate 116a are interlaced with the struts 117b of the second grate 116b such that the struts 117a of the first grate 116a extend into gaps between adjacent struts 117b of the second grate 116b), and the struts 117c of a third grate 116c may be nestled both in the spaces between the struts 117a of the first grate 116a and in the spaces between the struts 117b of the second grate 116b (e.g., the struts 117c of the third grate 116c are interlaced with the struts 117a of the first grate 116a and the struts 117b of the second grate 116b such that the struts 117c of the third grate 116c extend into gaps between adjacent struts 117a of the first grate 116a and into gaps between adjacent struts 117b of the second grate 116b), and so on and so forth. The grates 116 may be angled relative to each other in order to create the three dimensional grid pattern. The angle of the grates 116 relative to each other is not particularly limited, and may be tailored or adjusted to create the desired flow characteristics. However, in some embodiments, the grates 116 are generally at a 90° angle relative to each other (e.g., the first grate 116a, the second grate 116b, and the third grate 116c may be mutually orthogonal). That is, in one or more embodiments, the first grate 116a, the second grate 116b, and the third grate 116c may lie along mutually orthogonal (or substantially mutually orthogonal) planes.

Planar surfaces of the grates 116 may also be angled (i.e., canted) relative to the direction of flow of the melt through the randomizing element 112 (i.e., the planes on which the grates 116 lie are canted (i.e., non-orthogonal) relative to an axial direction of the printing nozzle 108). The angle of the grates 116 relative to the direction of the melt flow is not particularly limited so long as the spaces between the struts 117 of the grates 116 are oriented such that the melt can flow through the randomizing element 112 in alternating directions. This alternating flow through the randomizing element 112 enables active mixing of the melt as it flows through the randomizing element 112, which, in turn, keeps the fiber elements and/or the fillers in the mix in a random orientation and prevents alignment of the fibers and/or the fillers along an axial direction (i.e., along the inner walls of the printing nozzle 108). In some embodiments, however, the grates 116 may have an angle of about 45° relative the melt flow direction.

The number of grates 116 used to form the three dimensional grid pattern is also not particularly limited, and can generally be tailored to deliver the desired flow characteristics through the modules and the randomizing element. In some embodiments, however, each module 115 has from 4 to 8 grates, for example, 6 grates. In a 6 grate embodiment, for example, the module 115 may include three grates 116 extending in a first direction, and three grates 116 extending in a second direction, with the struts 117 of the second three grates passing through and resting in the spaces between the struts of the first three grates 116, as generally shown in FIGS. 4A-4C.

Additionally, the grates 116 in the same module need not all be the same size. Indeed, in some embodiments, the grates are differently sized such that the module has a particular size and orientation. For example, as shown in FIG. 4B, the module 115 when viewed from the side may include two grates 116a and 116b that form an “X” shape. These two grates 116a and may be larger than the remaining grates in the modules. As shown in FIG. 4B, for example, the remaining four grates 116c, d, e, and f are shorter than the first two grates 116a and b, and generally form a “box” shape or “window frame” that appears inside and encompassing the “X” shape of the first two grates when the module is viewed from the side.

In some embodiments, this “X” grid pattern provides a visual cue as to how the modules 115 may be arranged together to form the randomizing element. For example, while the arrangement of the modules is not particularly limited, in some embodiments, the modules may be arranged with the “X” shape along the axial direction, as shown in FIG. 4B. The adjacent module 115 may then be placed either in the same orientation and direction, or in a different orientation or direction. When the adjacent modules 115 are arranged in the same orientation and direction, the flow through the randomizing element may be more uniform, creating a faster flow rate since the pathway through the randomizing element may be more continuous through the spaces between the grates 117. However, in some embodiments, as shown in FIGS. 4A-4B (and described more below), adjacent modules may be rotated relative to the first module. The degree or angle of rotation is not particularly limited, but in some embodiments, may be about 90°. The rotation of adjacent modules 115 relative to each other may improve randomization of the fiber elements in the melt passing through the randomizing element by creating tortuous pathways through the randomizing element.

The flow characteristics may also be adjusted or tailored by adjusting the number of modules 115 in the randomizing element, which, in turn, adjusts the length of the randomizing element for a given size of the modules 115. In some embodiments, for example, the randomizing element 112 may include only a single module 115, as a single module 115 may provide adequate randomization of fiber elements in the polymer melt for certain compositions. However, in other embodiments, the randomizing element 112 may include two or more modules 115 connected to each other (e.g., by welding or other suitable connection). When the randomizing element 112 includes two or more modules, the modules are connected along the length (or long) dimension. Additionally, in some embodiments, the modules 115 may be connected so that they all have the same orientation and direction. However, as discussed above, in some embodiments, to improve randomization of the fiber elements, the modules 115 may be rotated relative to each other so that they have a different orientation and/or direction. The number of modules 115 that are rotated, and the angle of the rotation are not particularly limited. But in some embodiments, the modules 115 may be arranged in an alternating pattern in which every other module 115 is rotated 90° relative to the preceding and subsequent module, as shown generally in FIG. 4B. However, it is understood that the modules 115 need not be arranged in an alternating pattern, and may instead have a random pattern in which a random selection of modules 115 are rotated relative an adjacent module 115. The number of modules 115 in the randomizing element 112 is not particularly limited, and may vary depending on the length of the printing nozzle, the composition of the melt, etc. In some embodiments, for example, the randomizing element 112 may have from 1 to 10 modules. In one or more embodiments, the randomizing element 112 may have from 1 to 8 modules.

Some nonlimiting examples of suitable alternative geometries and configurations for the randomizing element are described, for example, in U.S. Pat. No. 9,777,973 to Neusser, titled “DEVICE FOR MIXING AND HEAT EXCHANGE,” filed Aug. 8, 2014 and issued on Oct. 3, 2017, the entire content of which is incorporated herein by reference (though it is understood that the randomizing element 112 disclosed herein need not include the channels described in this reference as the randomizing element 112 is not used in this disclosure for heat exchange), and U.S. Pat. No. 8,360,630 to Schneider, titled “MIXING ELEMENT FOR A STATIC MIXER AND PROCESS FOR PRODUCING SUCH A MIXING

ELEMENT,” filed Jan. 31, 2007 and issued on Jan. 29, 2013, the entire contents of which are incorporated herein by reference (though it is understood that the modules 115 disclosed herein need not be attached to each other in the manner described in this reference, and may instead be 3-D printed or otherwise manufactured, and welded together or otherwise connected by any suitable means). Indeed, any geometries and configurations used in conventional static mixers and melt blenders may be used in the randomizing element 112. For example, some additional suitable geometries and configurations for the randomizing element 112 and modules 115 include those used in the static mixers and melt blenders available from Promix Solutions AG (Germany) and Stamixco, LLC (New York), which are depicted and described at https://www.promix-solutions.ch/melt-blender-portfolio.html, http://www.stamixco-usa.com/products and https://www.stamixco.com/en/mixing-systems/mixer-for-extrusion.htm.

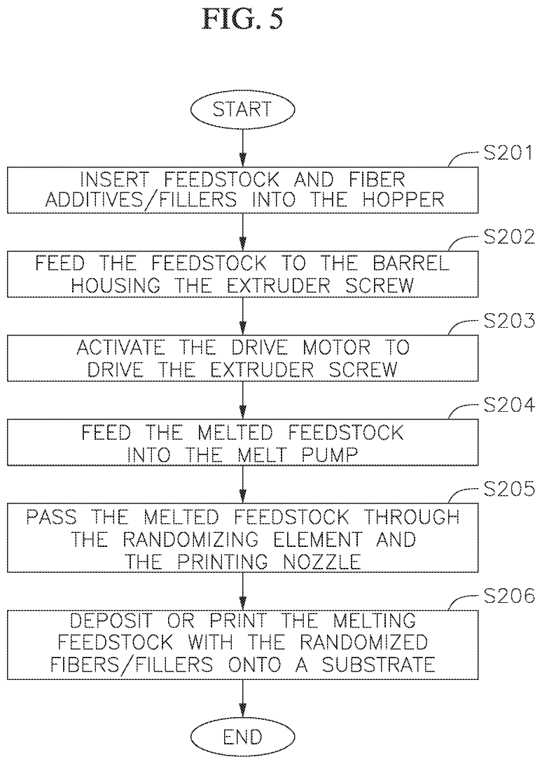

Embodiments of the present disclosure are also directed to methods of randomizing fiber additives in an extrusion melt, and to methods of printing (or extruding, or additively manufacturing) an extrusion melt (e.g., a polymeric composition) having fiber additives. In some embodiments, for example, as shown in the flowchart of FIG. 5, the method includes adding a raw polymeric composition including a fiber additive to the hopper of an extrusion line. The extrusion line may be any suitable extrusion line, for example, the extrusion system described above. The components of the extrusion line are also described above, and their descriptions are incorporated by reference here. The polymeric composition may be any suitable polymeric composition capable of extrusion or other additive manufacturing or printing. Some nonlimiting examples of suitable polymeric compositions are described in co-pending U.S. Provisional No. 62/882,423 titled “POLYMER COMPOSITIONS CAPABLE OF INDUCTION HEATING FOR EXTRUSION AND ADDITIVE MANUFACTURING PROCESSES,” filed on Aug. 2, 2019 in the name of Airtech International, Inc., the entire content of which is incorporated herein by reference, co-pending U.S. Provisional Application No. 62/882,425 titled “ADJUSTABLE CTE POLYMER COMPOSITIONS FOR EXTRUSION AND ADDITIVE MANUFACTURING PROCESSES,” filed on Aug. 2, 2019 in the name of Airtech International, Inc., the entire content of which is incorporated herein by reference, and co-pending U.S. Provisional Application No. 63/003,118, titled “POLYMER COMPOSITIONS CAPABLE OF INDUCTION HEATING FOR COATING COMPOSITE TOOLS,” filed on Mar. 31, 2020 in the name of Airtech International, Inc., the entire content of which is incorporated herein by reference.

As shown in FIG. 5, after the polymer composition (also referred to herein as the “feedstock”) including fiber additives and/or fillers has been placed in the hopper (S201), the feedstock is fed to the barrel housing the extruder screw (S202) where the screw motor is activated to drive the extruder screw (S203) (e.g., the extruder screw is activated to rotate before inserting the feedstock into the hopper). Upon activation of the screw motor, the extruder screw rotates which pushes the feedstock longitudinally along the length of the barrel toward the printing end of the extrusion system. In some embodiments, the barrel may include one or more heat zones along its length, which may have the same or different temperatures, as generally discussed above in connection with the extrusion system. As the feedstock is pushed along the length of the barrel by the rotating extruder screw, the feedstock generates heat by friction (as also discussed generally above), and may pass through the one or more heat zones which may aid in melting the feedstock and/or improving flow through the barrel. When the feedstock reaches a certain position along the barrel (e.g., approximately one-quarter of the way down the barrel from the connection between the feed throat and the barrel), the feedstock is melted (and is also referred to herein as the “melt”) and fed into the melt pump at the printing end of the extrusion system (S204). The melt pump then pumps the melt to the nozzle heater (S205), which heats the melt to a suitable temperature for printing. The temperature suitable for printing will depend on the composition of the feedstock (or melt) and is generally dictated by a desired melt viscosity and flow rate. Those of ordinary skill in the art are capable of selecting an appropriate viscosity and flow rate based on the composition of the feedstock (or melt). Passing the melt through the melt pump is configured to meter out the melt in a predictable, linear fashion (e.g., generally independent of the melt material's rheological properties, which are often nonlinear) such that bead geometries can be maintained with high accuracy at different gantry speeds and accelerations. In one or more embodiments, the system may not include a melt pump and therefore the method may not include a task of passing the melt through a melt pump.

When the randomizing element partially extends into the nozzle heater (according to embodiments of the system as discussed above), the melt may enter the nozzle heater via the inner tubing or channel housing the randomizing element. However, when the randomizing element does not extend into the nozzle heater, and is positioned solely within the printing nozzle, the inner tubing or channel housing the randomizing element may be omitted, and the melt may simply enter an inner chamber of the nozzle heater.

Upon entering the nozzle heater, the feedstock (or melt) is heated to ensure appropriate viscosity and flow (as discussed above), and then passes to the printing nozzle (S205). In embodiments in which the randomizing element partially extends into the nozzle heater, the melt enters the printing nozzle from the inner tubing or channel housing the randomizing element in the nozzle heater. The melt then continues along the length of the randomizing element in the printing nozzle until it reaches the printing exit port where the melt exits the printing nozzle and is printed (or deposited) on the intended substrate. In embodiments in which the randomizing element is housed wholly within the printing nozzle, however, the melt enters the printing nozzle from the inner chamber of the nozzle heater, and encounters the randomizing element either at the entrance to the printing nozzle or somewhere along the length of the printing nozzle (i.e., wherever the randomizing element is located). The melt then extends along the randomizing element within the printing nozzle until it exits through the printing exit port and is deposited (or printed) onto the desired substrate (S206).

Although various embodiments of the disclosure have been described, additional modifications and variations will be apparent to those skilled in the art. For example, the compositions disclosed as useful with the systems and apparatus may have additional components, which may be present in various suitable amounts, for example, other additives suitable to improve and/or modify the properties of the polymer compositions being extruded or printed by the systems or apparatus. Similarly, the various components of the systems or apparatus may be replaced or modified in accordance with the knowledge in the field to which the various embodiments pertain. For example, while the extruder screw is generally described herein as a single extruder screw, the extruder screw may instead be a twin extruder screw. Additionally, any of the components of the systems and apparatus may be modified to have any suitable dimensions or other parameters, depending on the intended use of the systems and apparatus or on the compositions intended to be extruded or printed by the systems and apparatus. Further, the systems and apparatus may be operated at various temperatures and speeds, and/or may be otherwise suitably modified to operate as desired. As such, the disclosure is not limited to the embodiments specifically disclosed, and the apparatus, systems and methods may be modified without departing from the disclosure.

Throughout the text and claims, any use of the word “about” reflects the penumbra of variation associated with measurement, significant figures, and interchangeability, all as understood by a person having ordinary skill in the art to which this disclosure pertains. Further, when used herein, the terms “substantially” and “generally” are used as terms of approximation and not as terms of degree, and are intended to account for normal variations and deviations in the measurement or assessment associated with the various components of the apparatus, systems, and methods.

What is claimed is:

1. An extrusion system, comprising:
an extruder screw housed in a barrel;
a nozzle heater coupled to the barrel;
a printing nozzle coupled to the nozzle heater; and
a randomizing element at least partially in the printing nozzle, the randomizing element configured to randomize an orientation of fiber elements and/or fillers in an extrusion melt traveling through the extrusion system.

2. The extrusion system of claim 1, wherein at least a portion of the randomizing element is housed in the nozzle heater.

3. The extrusion system of claim 1, wherein the randomizing element is flush with an exit port of the printing nozzle.

4. The extrusion system of claim 1, wherein the randomizing element is spaced apart from an exit port of the printing nozzle.

5. The extrusion system of claim 1, wherein the printing nozzle comprises a tapered neck proximate to the exit port, and wherein the randomizing element comprises a tapered portion in the tapered neck of the printing nozzle.

6. The extrusion system of claim 1, wherein the randomizing element comprises a plurality of modules coupled together, and wherein a configuration of a first module of the plurality of modules is different than a configuration of a second module of the plurality of modules adjacent to the first module.

7. The extrusion system of claim 6, wherein each module of the plurality of modules comprises a plurality of grates, the plurality of grates being meshed together in a three-dimensional grid pattern.

8. The extrusion system of claim 7, wherein each grate of the plurality of grates comprises a plurality of struts extending in a common direction, and wherein adjacent struts of the plurality of struts are spaced apart from each other by a gap.

9. The extrusion system of claim 7, wherein the plurality of grates comprises a first grate, a second grate, and a third grate arranged mutually orthogonally.

10. The extrusion system of claim 1, further comprising a melt pump.

11. The extrusion system of claim 7, wherein each grate of the plurality of grates is canted relative to an axial direction of the printing nozzle.

12. A method of randomizing fiber elements and/or fillers in a melted polymer composition to be printed by an extrusion system, the method comprising:
supplying a feedstock comprising the fiber elements and/or the fillers to an extruder screw of the extrusion system;
melting the feedstock as the feedstock moves along the extruder screw to form a melted composition comprising the fiber elements and/or the fillers; and
randomizing the orientation of the fiber elements and/or the fillers in a printing nozzle of the extrusion system.

13. The method of claim 12, further comprising metering in a linear fashion the melted composition with a melt pump of the extrusion system.

14. The method of claim 12, wherein less than 70% of the fiber elements and/or the fillers in a central portion of the bead are aligned along an axial direction of the bead after the printing.

15. The method of claim 14, wherein less than 90% of the fiber elements and/or the fillers in an outer portion of the bead are aligned along an axial direction of the bead after the printing.

16. A method of printing a part by additive manufacturing, the method comprising:
supplying a feedstock to an extruder screw housed in a barrel of an extrusion system, the feedstock comprising fiber elements and/or fillers;
heating the barrel of the extrusion system to melt the feedstock while it travels along the extruder screw to form a melted composition comprising the fiber elements and/or the fillers;
randomizing the orientation of the fiber elements and/or the fillers in the melted composition by passing the melted composition through a randomizing element at least partially in a printing nozzle of the extrusion system; and
printing, with the printing nozzle, the melted composition into a bead to form at least a portion of the part, wherein the fiber elements and/or the fillers remain randomized after the printing.

17. The method of claim 16, further comprising metering in a linear fashion, with a melt pump, the melted composition to the randomizing element in the printing nozzle.

18. The method of claim 16, wherein less than 70% of the fiber elements and/or the fillers in a central portion of the bead are aligned along an axial direction of the bead after the printing.

19. The method of claim 18, wherein less than 90% of the fiber elements and/or the fillers in an outer portion of the bead are aligned along an axial direction of the bead after the printing.
